(19) United States
(12) Patent Application Publication
(10) Pub. No.: US 2013/0022791 A1
(43) Pub. Date: Jan. 24, 2013

(54) METHOD FOR COATED PRODUCT AND PRODUCT MANUFACTURED BY SAME

(71) Applicant: DA-HUA CAO, Shenzhen City (CN)

(72) Inventor: DA-HUA CAO, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/237,392

(22) Filed: Sep. 20, 2011

(30) Foreign Application Priority Data
Jul. 18, 2011 (CN) 201110200410.7

(51) Int. Cl. C08F 2/48; B32B 3/30

(52) U.S. Cl. 428/172; 427/492

(57) ABSTRACT

A method for a coated product, comprising: providing a substrate; forming a color coating on the substrate; forming a top coating on the color coating, the paint used for the top paint is ultraviolet curable paint; providing a stamping die, the stamping die includes a plurality of molding surface; stamping the substrate with the stamping die, the molding surface abuts against the top coating; heat-curing the substrate while still in contact with the stamping die, the ultraviolet light struggled in the top coating through the stamping die to curing the top coating; curing the top paint coating again without the stamping die.

### BACKGROUND

1. Technical Field

The exemplary disclosure generally relates to coated products, particularly to a method for coating a product to have a color-changeable pattern and product manufactured by the method.

2. Description of Related Art

Anodizing, spray painting, and electrophoretic deposition may all be used to form color patterns on housings of portable electronic devices. However, to form multi-color patterns a treatment must be applied several times, which is complex and expensive. Additionally, for environmental reasons and for certain desirable characteristics, ultraviolet curable paint is used to coat housings. However, to cure such coatings during a stamping process of a substrate to form housing, the substrate should be transparent for the transmission of the ultraviolet light which lead the substrate made of metal cannot use in the process.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the exemplary method for a coated product and product manufactured by the method. Moreover, in the drawings like reference numerals designate corresponding parts throughout the several views. Wherever possible, the same reference numbers are used throughout the drawings to refer to the same or like elements of an embodiment.

FIG. 1 is a cross-section partial view of an exemplary embodiment of a coated product.

FIG. 2 is a schematic view of a stamping die for manufacturing the product of FIG. 1.

### DETAILED DESCRIPTION

An exemplary method for a coated product with a color-changeable pattern may include at least the following steps:

A substrate 11 is provided. The substrate 11 may be made of metal, such as stainless steel, aluminum, aluminum alloy, magnesium and magnesium alloy.

The substrate 11 is pretreated by washing with a solution (e.g., alcohol or acetone) in an ultrasonic cleaner to remove contaminants, such as grease or dirt. The substrate 11 is then dried.

A base coating 13 is formed on the substrate 11 by painting. The paint used for the base coating 13 can be bakeable paint or ultraviolet (UV) curable paint and is selected to provide a transparent layer with a smooth surface for enhancing the bonding between the base coating 13 and subsequent coatings. The paint is applied to provide a base coating 13 that is about 3 μm to about 5 μm thick.

A color coating 15 is formed on the base coating 13 by screen printing or gravure printing in this embodiment, but may be formed by spray painting or physical vapor deposition in other embodiments. In this embodiment, paint that can be air dried is selected and applied to form a color coating 15 having a thickness of about 15 μm to about 20 μm.

A top coating 17 is formed on the color coating 15 by screen printing or spray painting. The paint used for the top coating 17 can be UV curable paint and chosen for having high abrasion and scratch resistant properties and is applied to form a top coating 17 having a thickness of about 10 μm to about 15 μm.

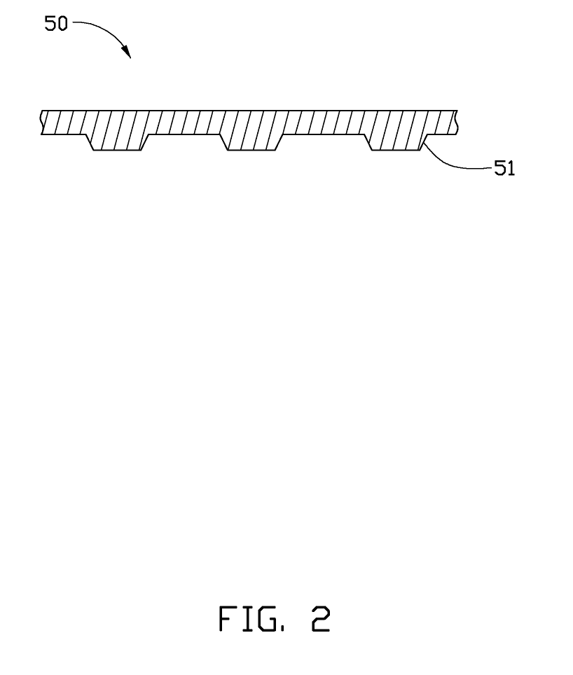

A stamping die 50 is provided. Referring to FIG. 2, the stamping die 50 is made of a hard material with high light transmission, such as polymethyl methacrylate (PMMA) or polycarbonate (PC). The stamping die 50 includes a molding surface 51. The molding surface has several protrusions formed thereon, so that when die 50 is used to stamp the substrate 11, the top coating 17 is left with a series of concavities 171 and convexities 173

The substrate 11 is stamped using the die 50, and the concavities 171 and the convexities 173 combine to form a convexo-concave pattern.

Then the substrate 11 is heat-cured while still in contact with the stamping die 50 and UV light is irradiated onto the top coating 17 through the stamping die 50 to cure the top coating 17. In this embodiment, the UV curable paint selected should be exposed to UV light having a wavelength in a range from about 300 nm to about 380 nm, at an energy of between about 800 mJ/cm² to about 1200 mJ/cm², with linear speed of about 0.05 m/s to about 0.2 m/s, at an exposure time of about 0.25 min to about 1 min.

The stamping die is then removed and the top coat is exposed to UV light again in a final curing step. The wavelength of the UV light is in a range from about 300 nm to about 380 nm, at an energy between about 1200 mJ/cm² to about 1600 mJ/cm², at a linear speed of about 0.05 m/s to about 0.2 m/s, at an exposure time of about 0.25 min to about 1 min.

The substrate 11 is punched to form a desired shape for use in a product 10. Thus, any part of the outer surface of the product 10 may be presented with a convexo-concave pattern that can vary the wavelength of light reflected by the product 10, thereby creating a multi-color effect.

In some applications, it may be desirable to use a substrate that is made of non-metal material, such as plastic, glass or ceramic, and the above mention steps adjusted accordingly.

If the paint chosen for the color coating 15 will bond well with the material chosen for the substrate 11, then the base coating 13 can be omitted.

Because the top coating 17 can be irradiated through the transparent die 50, it is not necessary to limit the material of the substrate 11 and the base coating 13 to transparent materials. Thus, other materials can be chosen for desirable qualities such as relatively greater strength, while allowing for attractive patterning to be accomplished without incurring greater costs of manufacture.

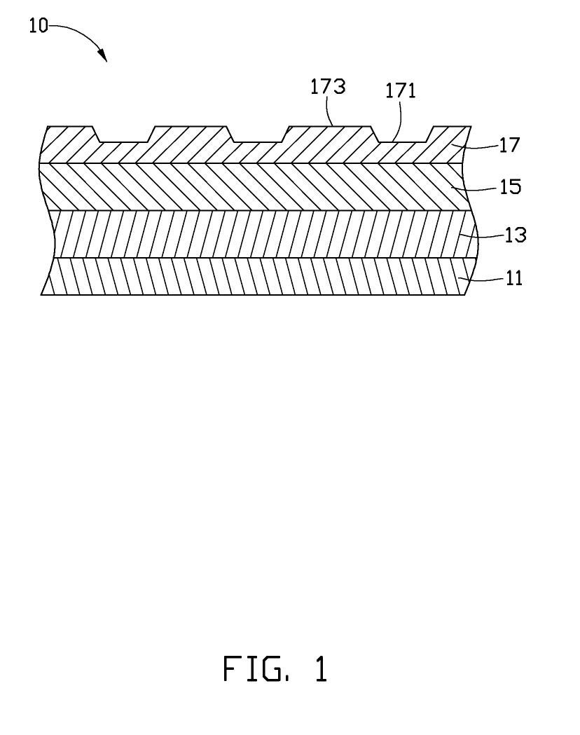

FIG. 1 shows a portion of an exemplary embodiment of a product 10 manufactured by the method as described above. The product 10 may be a housing of a mobile phone, personal digital apparatus (PDA), note book computer, MP3, MP4, GPS navigator, or digital camera.

The product 10 includes a substrate 11, a base coating 13 formed on the substrate 11, a color coating 15 formed on the base coating 13, and a top coating 17 formed on the color coating 15. The substrate 11 may be made of metal, such as stainless steel, aluminum, aluminum alloy, magnesium and magnesium alloy. The substrate 11 may stead be made of plastic, glass or ceramic.

The outer surface of the top coating 17 has a plurality of concavities 171 alternated with a plurality of convexities 173. The concavities 171 and convexities 173 in combination form a convexo-concave pattern.

The depth of the concavities 171 is about 8 mm to about 15 mm. The minimum width of the concavities 171 is about 0.016 mm.

The base coating 13 has a thickness of about 3 μm to about 5 μm. The color coating 15 has a thickness of about 15 μm to about 20 μm. The top coating 17 has a thickness of about 10 μm to about 15 μm.

Because there is a large difference between the thickness of the top coating 17 where the concavities 171 are and the thickness where the convexities 173 are, light reflected by the concavities 171 will have a different wavelength from light reflected by the convexities 173, so that when viewed there will be an apparent assortment of colors on the top coating 17. Furthermore, the apparent color of the product 10 may gradually change as the viewing angle changes. Thus, the product 10 has more visually interesting pattern. Additionally, the product 10 has high abrasion and scratch resistance.

It is to be understood, however, that even through numerous characteristics and advantages of the exemplary disclosure have been set forth in the foregoing description, together with details of the system and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A method for a coated product, comprising:
providing a substrate;
forming a color coating on the substrate;
forming a top coating on the color coating, the paint used for the top paint being ultraviolet curable paint;
providing a stamping die, the stamping die includes a plurality of molding surfaces;
stamping the substrate with the stamping die, the molding surface abutting against the top coating;
heat-curing the substrate while still in contact with the stamping die, the ultraviolet light is irradiated onto the top coating through the stamping die to cure the top coating;
removing the stamping die from contact with the substrate;
curing the top paint coating again after removing the stamping die.

2. The method of claim 1, wherein the stamping die is made of a hard material with high light transmission.

3. The method of claim 2, wherein the stamping die is made of material selected from one of polymethyl methacrylate and polycarbonate.

4. The method of claim 1, wherein the color coating is formed by screen printing, gravure printing, spray painting or physical vapor deposition.

5. The method of claim 1, wherein during heat-curing the substrate while still in contact with the stamping die, the top coating is exposed to ultraviolet light having a wavelength in a range from about 300 nm to about 380 nm, at an energy of between about 800 mJ/cm² to about 1200 mJ/cm², with linear speed of about 0.05 m/s to about 0.2 m/s, at an exposure time of about 0.25 min to about 1 min.

6. The method of claim 1, wherein during curing the top paint coating again, the wavelength of the ultraviolet light is in a range from about 300 nm to about 380 nm, at an energy between about 1200 mJ/cm² to about 1600 mJ/cm², at a linear speed of about 0.05 m/s to about 0.2 m/s, at an exposure time of about 0.25 min to about 1 min.

7. The method of claim 1, wherein when the substrate is made of metal or plastic, the method further comprising a step of punching the substrate after curing the top paint coating again.

8. A coated product, comprising:
a substrate;
a color coating formed on the substrate; and
a top coating formed on the color coating, the paint used for the top coating being ultraviolet curable paint, the outer surface of the top coating comprising a plurality of concavities.

9. The coated product as claimed in claim 8, wherein the depth of the concavities is about 8 mm to about 15 mm.

10. The coated product as claimed in claim 8, wherein the minimum width of the concavities is about 0.016 mm.

11. The coated product as claimed in claim 8, wherein the base coating has a thickness of about 3 μm to about 5 μm.

12. The coated product as claimed in claim 8, wherein the color coating has a thickness of about 15 μm to about 20 μm.

13. The coated product as claimed in claim 8, wherein the top coating has a thickness of about 10 μm to about 15 μm.

14. The coated product as claimed in claim 8, wherein the substrate is made of material selected from one of metal, plastic, glass and ceramic.
